(19) United States
(12) Patent Application Publication
(10) Pub. No.: US 2015/0066821 A1
(43) Pub. Date: Mar. 5, 2015

(54) OBSERVATION VALUE PREDICTION DEVICE AND OBSERVATION VALUE PREDICTION METHOD

(71) Applicant: HONDA MOTOR CO., LTD., Tokyo (JP)

(72) Inventors: Tomoaki NAKAMURA, Wako-shi (JP); Takayuki NAGAI, Tokyo (JP)

(21) Appl. No.: 14/467,151

(22) Filed: Aug. 25, 2014

(30) Foreign Application Priority Data
Sep. 2, 2013 (JP) 2013-181269

(51) Int. Cl. G06N 7/00; G06N 99/00

(52) U.S. Cl. CPC G06N 7/005; G06N 99/005
USPC 706/12

(57) ABSTRACT

A prediction device includes an observation unit configured to obtain an observation value of a target object, a learning unit configured to learn a transition probability and a probability distribution of a model, including the transition probability between a plurality of states and the probability distribution of the observation value which corresponds to each state, from time series data of the observation value, a prediction unit configured to predict a state at a predetermined time based on the transition probability and to predict an observation value corresponding to the state at the predetermined time based on the probability distribution using the time series data of the observation value before the predetermined time.

### BACKGROUND

1. Technical Field

The invention relates to an observation value prediction device and an observation value prediction method, which are used in a robot and the like.

2. Related Art

For example, a method of acquiring a physical knowledge is developed, in which in a case where a robot performs an operation on an object and as a result the object is moved, a hidden Markov model is used to learn a relation between the operation of the robot and a track of the object based on time series information of the robot itself and time series information of the object visually observed (for example, Komei Sugiura, Naoto Iwahashi, Hideki Kashioka, “HMM Synthesis by Penalized Likelihood Maximization for Object Manipulation Tasks,” Department lecture, SICE System Integration, pp. 2305-2306, 2012). In methods according to the related art including the above method, a track is generated by generalizing and reproducing the learned track. Therefore, the methods according to the related art do not generate an unknown track of the object from an unknown operation of the robot which has not been learned. In other words, when the track of the object is assumed as an observation target object, an unknown observation value not learned is hardly predicted. As described above, there is no development in the related art on a prediction device and a prediction method which can predict an unknown observation value not learned.

### SUMMARY

As described above, the prediction device and the prediction method which can predict an unknown observation value not learned has not been put to practical use. Therefore, there is a need for the prediction device and the prediction method which can predict an unknown observation value not learned.

A prediction device according to a first aspect of the invention includes: an observation unit configured to acquire an observation value of an observation target object; a learning unit configured to learn a transition probability and a probability distribution of a model from time series data of the observation value, wherein the model represents states of the observation target object and includes the transition probability between a plurality of states and the probability distribution of the observation value which corresponds to each state; and a prediction unit, using the time series data of the observation value before a predetermined time, configured to predict a state at the predetermined time based on the transition probability and to predict an observation value corresponding to the state at the predetermined time based on the probability distribution.

According to the prediction device of the aspect, the unknown observation value not learned can be predicted by using the model representing states of the observation target object and including the transition probability between the plurality of states and the probability distribution of the observation value which corresponds to each state.

In the prediction device according a first embodiment of the first aspect of the invention, the prediction unit is configured to obtain the state at the predetermined time and a plurality of sampling values of the observation value corresponding to the state, and set an average value of the plurality of sampling values to a prediction value of the observation value.

According to the embodiment, a prediction value can be simply obtained by setting the average value of the plurality of sampling values to the prediction value of the observation value.

In the prediction device according to a second embodiment of the first aspect of the invention, the observation value includes a position and a speed of the observation target object, and the prediction unit is configured to perform the prediction using the probability distribution of the position of the observation target object.

According to the embodiment, since a position of the object satisfying a dynamic constraint can be generated, a smooth track of the object can be generated.

In the prediction device according to a third embodiment of the first aspect of the invention, the model is a hierarchical Dirichlet process-hidden Markov model and the learning unit is configured to perform learning by Gibbs sampling.

According to the embodiment, there is no need to determine the number of states in advance, and the number of optimal states can be estimated according to the complexity of learning data.

A prediction method according to a second aspect of the invention predicts an observation value using a model, in which the model represents states of an observation target object and includes a transition probability between a plurality of states and a probability distribution of an observation value which corresponds to each state. The prediction method includes obtaining an observation value of the observation target object, learning the transition probability and the probability distribution of the model from time series data of the observation value, and predicting, using the time series data of the observation value before a predetermined time, a state at the predetermined time based on the transition probability and to predict an observation value corresponding to the state at the predetermined time based on the probability distribution.

According to the prediction method of the aspect, the unknown observation value not learned can be predicted by using the model representing states of the observation target object and including the transition probability between the plurality of states and the probability distribution of the observation value which corresponds to each state.

### BRIEF DESCRIPTION OF DRAWINGS

FIG. 1 is a diagram illustrating a configuration of a prediction device which predicts an observation value of a target object according to an embodiment of the invention;

FIG. 2 is a diagram for describing a model;

FIG. 3 is a flowchart for describing a sequence of learning a model by a learning unit;

FIGS. 4A and 4B are diagrams illustrating a concept of learning by the learning unit;

FIG. 5 is a flowchart illustrating a sequence of prediction by a prediction unit;

FIG. 6 is a diagram illustrating states before time Tarm at which observation is performed and a state after a collision (after time Tarm+1);

FIGS. 7A and 7B are diagrams illustrating a concept of prediction by the prediction unit;

FIG. 8 is a diagram illustrating a track of an arm and a track of an object (a sphere);

FIG. 9 is a diagram illustrating six states which are obtained by learning;

FIGS. 10A to 10C are diagrams illustrating a known track which is generated by the prediction unit; and

FIGS. 11A and 11B are diagrams illustrating an unknown track which is generated by the prediction unit.

### DETAILED DESCRIPTION

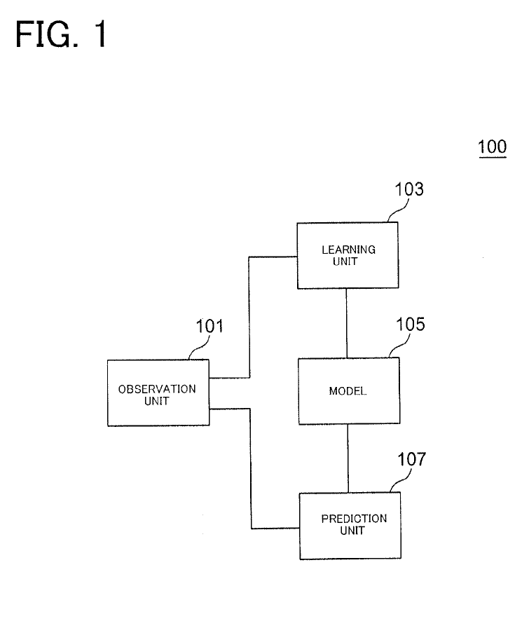

FIG. 1 is a diagram illustrating a configuration of a prediction device 100 which predicts an observation value of a target object according to an embodiment of the invention. The prediction device 100 which predicts the observation value includes an observation unit 101 which acquires the observation value of the target object, a model 105 which expresses a state of the target object and a relation between the state of the target object and the observation value, a learning unit 103 which learns the model 105 according to the observation value, and a prediction unit 107 which predicts a future observation value using the model 105. The model 105 is, for example, stored in a memory unit of the prediction device 100.

As an example, in a case where a robot performs an operation on an object using an arm, the arm and the object become the observation target objects. For example, an axis in a lateral direction, when viewed the robot in the front, is assumed as an x axis, and an axis in a longitudinal direction thereof is assumed as a y axis. The x coordinate and the y coordinate in front of the robot, and differences in these coordinates are used as total 4-dimensional information of the arm (the observation value), and similarly, the x coordinate and the y coordinate of the object and differences in these coordinates are used as the total 4-dimensional information (the observation value) of the object.

The observation unit 101 is configured to acquire the observation values of the arm and the object value using an image pickup device or various types of sensors of the robot. In other words, the observation unit 101 acquires the observation value of an observation target object (for example, the object), and also acquires other data (for example, position information of the arm of the robot) if necessary.

When the robot touches the object, the prediction device 100 observes the movement of the robot itself and the movement of the object and learns and predicts a relation between these movements. Through the learning, the robot can gain “knowledge” such as that a round object rolls over when being touched, that the round object rolls over further far away when being touched with a stronger force, or that a square object and a heavy object are hard to roll over. Of course, the movement of the object can be predicted with a high accuracy through a physical simulation. However, the physical simulation requires parameters which are difficult to be directly observed such as a mass of the object, a friction factor, and the like. On the other hand, a person can predict a movement (track) of the object by using knowledge gained through experience based on visually-acquired information without using such parameters. Therefore, learning and predicting by the above-mentioned prediction device 100 are important also for the robot.

As described above, the prediction device 100 uses time series information on the position of the arm and time series information on the position of the object obtained from the observation unit 101. Hitherto, a hidden Markov model (HMM) has been used for the learning of the track of the object, the operation of the robot, and the like (Komei Sugiura, Naoto Iwahashi, Hideki Kashioka, “HMM Synthesis by Penalized Likelihood Maximization for Object Manipulation Tasks,” Department Lecture, SICE System Integration, pp. 2305-2306, 2012). In the HMM, the number of states has to be given in advance. However, in the embodiment, since the number of optimal states is different according to the operation of the robot and the object, it is difficult to set the number of states in advance. Thus, the prediction device 100 employs a hierarchical Dirichlet process-hidden Markov model (HDP-HMM) in which a hierarchical Dirichlet process (HDP) is introduced to the HMM (M. J. Beal, Z. Ghahramani, and C. E. Rasmussen, “The infinite hidden Markov model”, Advances in neural information processing systems, pp. 577-584, 2001). The HDP-HMM is a model in which the number of states is not determined in advance and the number of optimal states can be estimated according to the complexity of learning data. In the embodiment, the HDP-HMM is further expanded to a multimodal HDP-HMM (MHDP-HMM) in which a plurality of pieces of time series information such as the object and the operation (that is, the movement of the arm) of the robot itself can be learned, and unsupervised learning on the operation of the robot itself and the track of the object is performed.

Such learning of the plurality of pieces of information using the MHDP-HMM enables a stochastic prediction on other not-observed information based on a piece of information. For example, even when the robot does actually not move yet, it is possible to predict a movement of the object based only on the movement to be made by the robot. The prediction on the track of the object can be realized by predicting a future state based on the obtained information and by generating a track of the object corresponding to the state.

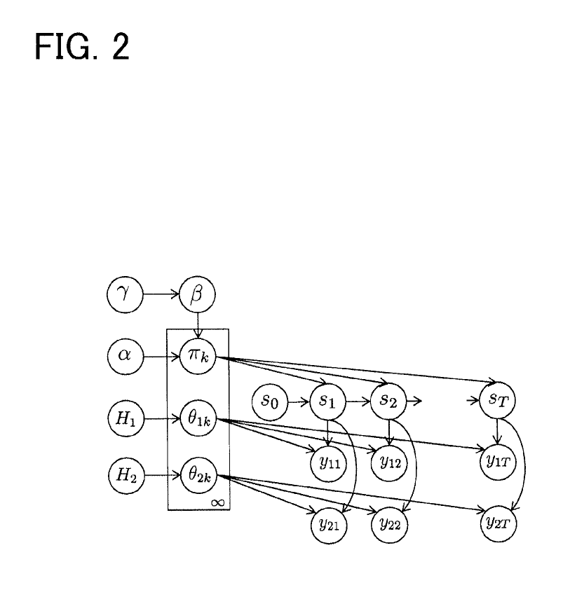

FIG. 2 is a diagram for describing the model 105. The model 105 is the MHDP-HMM in which the Dirichlet process is introduced to the HMM for the expansion to a model having an infinite state and the observation of a plurality of target objects are assumed. In FIG. 2, the following Expression 1 represents states, and the following Expressions 2 and 3 represent observation values which are output from the respective states.

(s₀,s₁, . . . , s_{T}) [Mathematical Formula 1]

(y₁₁,y₁₂, . . . , y_{1T}) [Mathematical Formula 2]

(y₂₁,y₂₂, . . . , y_{2T}) [Mathematical Formula 3]

(where, y₁* is information of the arm of the robot, and y₂* is information of the object.)

Each state represented by the following Expression 4 can take an infinite state represented by the following Expression 5.

sₜ (t=0, . . . , T) [Mathematical Formula 4]

k(=0, . . . , ∞) [Mathematical Formula 5]

(where, πₖ represents a probability to transition from state k to each state.)

The probability πₖ is calculated based on β which is generated by a GEM distribution (Stick Breaking Process) having γ as a parameter and the Dirichlet Process (DP) having α as a parameter (Daichi Mochihashi, “Recent Advances and Applications on Bayesian Theory (III): An Introduction to Nonparametric Bayesian Models” http://www.ism.ac.jp/˜daichi/paper/ieice10npbayes.pdf, Naonori Ueda, and another, “Introduction to Nonparametric Bayesian Models” http://www.kecl.ntt.co.jp/as/members/yamada/dpm_ueda_yamada2007.pdf, Yee Whye Teh, and three others, “Hierarchical Dirichlet Processes” http://www.cs.berkeley.edu/˜jordan/papers/hdp.pdf).

[Mathematical Formula 6]

β˜GEM(γ) (1)

πₖDP(α,β) (2)

Herein, regarding α and γ, a γ distribution is assumed as a prior distribution, and sampling is performed based on a posteriori probability (Yee Whye Teh, and three others, “Hierarchical Dirichlet Processes” http://www.cs.berkeley.edu/˜jordan/papers/hdp.pdf).

State sₜ at time t is determined by state sₜ₋₁ at time t−1 and a transition probability πₖ. Further, θ* is a parameter of a probability distribution to generate an observation value y*t, and in this case an average and a dispersion of the Gaussian distribution are assumed. Moreover, a Gaussian Wishart distribution is assumed as a prior distribution of the Gaussian distribution, and the parameter is denoted by H*. In other words, the following relations are established.

[Mathematical Formula 6]

sₜ˜M(πₛ_{_{t−1}}) (3)

θ*_{dk}˜P(θ*ₖ|H*) (4)

y*ₜ˜N(y|θ*_{,s}_{_{t−1}}) (5)

(where, M represents a multinomial distribution, P of Equation (4) represents a Gaussian Wishart distribution, and N represents a Gaussian distribution.)

In the model 105, the transition probability πₖ and the parameter θ*ₖ of the Gaussian distribution are obtained by learning.

Next, the learning of the model 105 will be described. The learning is realized by sampling state sₜ at each time t using Gibbs sampling. In the Gibbs sampling, sₜ is sampled out of the following conditional probability on condition of the remnants excluding sₜ.

[Mathematical Formula 8]

P(sₜ|s₋ₜ, β, Y₁, Y₂, α, H₁, H₂)∝P(sₜ|s₋ₜ, β, α)P(y₁ₜ|sₜ, s₋ₜ, Y_{1,-t}, H₁)×P(y₂ₜ|sₜ, s₋ₜ, Y_{2,-t}, H₂) (6)

In this case, each of Y₁ and Y₂ is a set of all the observation data. Further, a suffix −t means the remnants excluding a state at time t. In other words, s₋ₜ represents a state of all the time excluding sₜ, and Y₁, ₋ₜ, and Y₂, ₋ₜ represent the remnants in which y₁ₜ and y₂ₜ are excluded from Y₁ and Y₂, respectively. The following Expression 9 in Equation (6) can be expressed by the following Expression 10 through Bayesian inference.

P(y*ₜ|sₜ, s₋ₜ, Y*_{,-t}, H*) [Mathematical Formula 9]

[Mathematical Formula 10]

P(y*ₜ|sₜ, s₋ₜ, Y*₋ₜ, H*)=∫P(y*ₜ|sₜ, θₛ_{ₜ})P(θₛ_{ₜ}|s₋ₜ, Y*_{,-t}, H*)dθₛ_{ₜ} (7)

Further, Expression 11 is a state transition probability.

P(sₜ|s₋ₜ, β, α) [Mathematical Formula 11]

Expression 11 can be expressed by the following Expression 12 when the number of transition times from state i to state j is represented as nᵢⱼ.

$$P ( {s}_{t} \vert {s}_{- t} , β , α ) ∝ ( {n}_{{s}_{t - 1} , k} + {αβ}_{k} ) \frac{{n}_{k , {s}_{t + 1}} + {αβ}_{{s}_{t + 1}}}{{n}_{k \cdot } + α} if k \leq K , k \neq {s}_{t - 1} \\ ( {n}_{{s}_{t - 1} , k} + {αβ}_{k} ) \frac{{n}_{k , {s}_{t + 1}} + 1 + {αβ}_{{s}_{t + 1}}}{{n}_{k \cdot } + 1 + α} if k = {s}_{t - 1} = {s}_{t + 1} \\ ( {n}_{{s}_{t - 1} , k} + {αβ}_{k} ) \frac{{n}_{k , {s}_{t + 1}} + {αβ}_{{s}_{t + 1}}}{{n}_{k \cdot } + 1 + α} if k = {s}_{t - 1} \neq {s}_{t + 1} \\ {αβ}_{k} {β}_{{s}_{t + 1}} if k = K + 1 \qquad [ Mathematical Formula 12 ]$$

Herein, K is the number of current states, and in the case of k=K+1, it means that a new state is generated.

In Equation (6), a spatial constraint expressed by Equation (7) and a time constraint expressed by the equation of the state transition probability are taken into consideration.

The learning starts from a random initial value, and can be obtained by the transition probability (Expression 13) by repeating the sampling according to Equation (6), and the probability distribution (Expression 14) outputting an observation value according to a state.

P(s|s, β, α) [Mathematical Formula 13]

P(y*ₜ|s, Y*_{,-t}, H*) [Mathematical Formula 14]

Further, in the embodiment, hyper parameters α and β are also estimated through the sampling (Y. W. The, M. I. Jordan, M. J. Beal, and D. M. Blei, “Hierarchical Dirichlet processes,” Journal of the American Statistical Association, vol. 101, no. 101, no. 476, pp. 1566-1581, 2006).

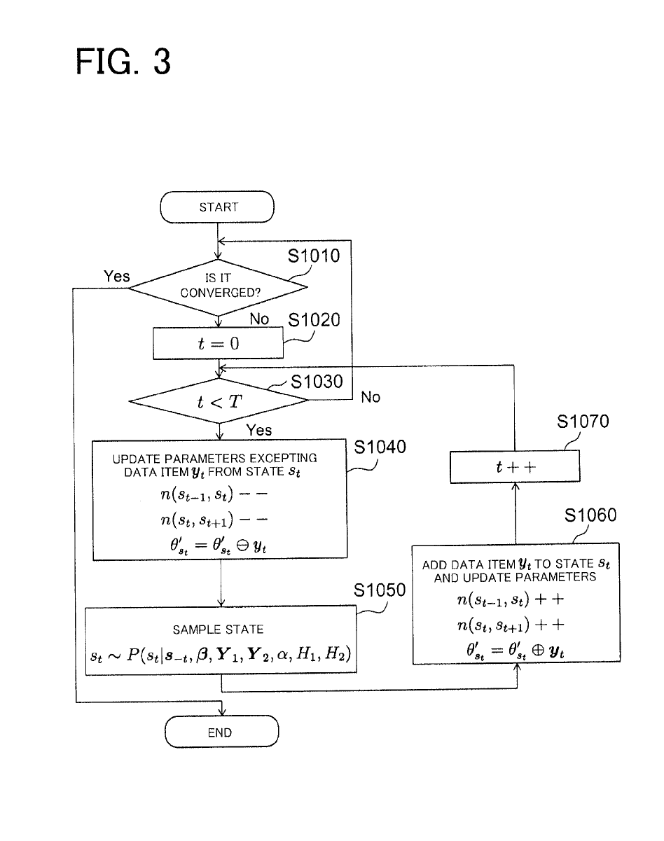

FIG. 3 is a flowchart for describing a sequence of learning the model 105 by the learning unit 103.

Herein, a parameter of a posteriori distribution of the Gaussian distribution corresponding to state sₜ is assumed as θ′ₛₜ. In other words, the following equation is established.

P(y*ₜ|sₜ, s₋ₜ, Y*_{,-t}, H*)=∫P(y*ₜ|sₜ, θₛ_{ₜ})P(θₛ_{ₜ}|s₋ₜ, Y*_{,-t}, H*)dθₛ_{ₜ}=P(y*ₜ|θ′ₛ_{ₜ}) [Mathematical Formula 15]

Further, updating the parameter of the posteriori distribution by adding an observation data item y is denoted by the following Expression 16.

θ′ₛ_{ₜ}=θ′ₛ_{ₜ}⊕y [Mathematical Formula 16]

On the contrary, updating the parameter of the posteriori distribution excepting the observation data item y is denoted by the following Expression 17.

θ′ₛ_{ₜ}=θ′ₛ_{ₜ}⊖y [Mathematical Formula 17]

In Step S1010 of FIG. 3, it is determined whether the learning unit 103 is converged. Specifically, the convergence is determined by a change in likelihood. In the case of convergence, the process is ended. In the case of no convergence, the process proceeds to Step S1020.

In Step S1020 of FIG. 3, the learning unit 103 initializes time as t=0.

In Step S1030 of FIG. 3, the learning unit 103 determines whether time reaches a predetermined time T. In a case where time does not reach the predetermined time T, the process proceeds to Step S1040. In a case where time reaches the predetermined time T, the process returns to Step S1010.

In Step S1040 of FIG. 3, the learning unit 103 updates parameters excepting a data item yₜ from state sₜ. In Step S1040, “−−” represents a decrease by 1.

In Step S1050 of FIG. 3, the learning unit 103 samples a state using Equation (6).

In Step S1060 of FIG. 3, the learning unit 103 adds the data item yₜ to state sₜ to update the parameter. In Step S1060, “++” represents an increase by 1.

In Step S1070 of FIG. 3, the learning unit 103 changes time as time goes by. In Step S1070, “++” represents an addition of an increment of time. After the process of Step S1070 is ended, the process returns to Step S1030.

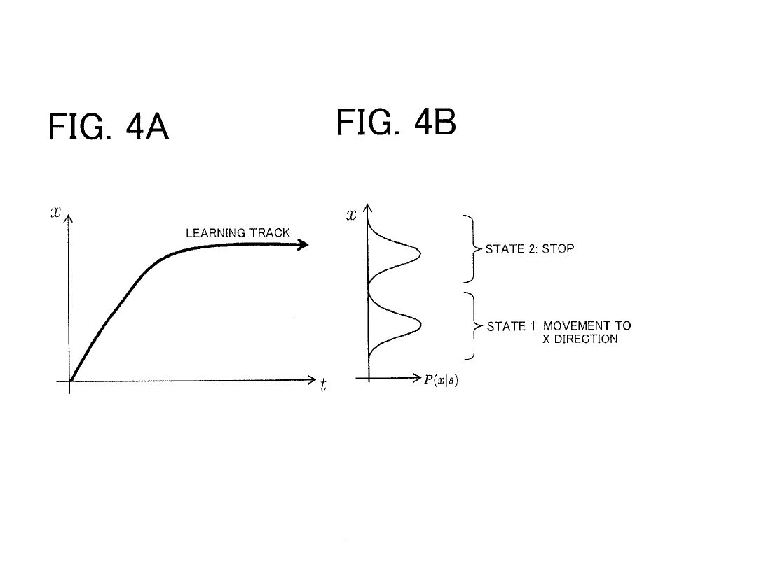

FIGS. 4A and 4B are diagrams illustrating a concept of learning by the learning unit 103. FIG. 4A is a diagram illustrating a relation between time and an observation value. The horizontal axis of FIG. 4A represents time, and the vertical axis represents the observation value. In FIGS. 4A and 4B, the observation values y₁ and y₂ are plotted in one dimension with respect to x. FIG. 4B is a diagram illustrating a probability distribution in each state. The horizontal axis of FIG. 4B represents a probability, and the vertical axis represents the observation value. The probability distribution of the observation values in each state conceptually illustrated in FIG. 4B is obtained by learning.

Next, the prediction on a position of an object using the model 105 will be described. In a case where position p₂,ₜ₋₁ of the object at time t−1 is given, position P₂,ₜ of the object at time t can be calculated by the following Equation (8). However, the following Expression 18 is established in consideration of a positional difference with respect to the position at the previous time as a dynamic feature.

y_{2,t}={p_{2,t}^{T}, (p_{2,t}−p_{2,t-1})^{T}}^{T} [Mathematical Formula 18]

[Mathematical Formula 19]

N(y_{2,t}|Σₛ_{ₜ}, μₛ_{ₜ})∝exp{(y_{2,t}−μₛ_{ₜ})^{T}Σₛ_{ₜ}⁻¹(y_{2,t}−μₛ_{ₜ})} (8)

Σₛ_{ₜ}, μₛ_{ₜ} [Mathematical Formula 20]

In this case, Expression 20 represents a dispersion and an average of the Gaussian distribution corresponding to state sₜ. Herein, assuming that position p₂,ₜ₋₁ is already known, Equation (8) can be modified into an equation depending only on position p₂,ₜ.

N(y_{2,t}|Σₛ_{ₜ}, μₛ_{ₜ})∝N(p_{2,t}, |Σ′, μ′) [Mathematical Formula 21]

In this case, Expression 22 is assumed as follows.

$$\begin{matrix}[ Mathematical Formula 22 ] & \\ {Σ}_{{s}_{t}}^{- 1} = [ \begin{matrix}{Σ}_{{s}_{t} , 11}^{- 1} & {Σ}_{{s}_{t} , 12}^{- 1} \\ {Σ}_{{s}_{t} , 21}^{- 1} & {Σ}_{{s}_{t} , 22}^{- 1}\end{matrix} ] , {μ}_{{s}_{t}} = [ \begin{matrix}{μ}_{{s}_{t} , 1} \\ {μ}_{{s}_{t} , 2}\end{matrix} ] & ( 9 )\end{matrix}$$

Σ′, μ′ [Mathematical Formula 23]

The following equations are established for Expression 23.

$$\begin{matrix}[ Mathematical Formula 24 ] & \\ \begin{matrix}{Σ}^{′} = {( {Σ}_{{s}_{t} , 11}^{- 1} + 2 {Σ}_{{s}_{t} , 21}^{- 1} + {Σ}_{{s}_{t} , 22}^{- 1} )}^{- 1} \\ {μ}^{′} = {( {Σ}_{{s}_{t} , 11}^{- 1} + 2 {Σ}_{{s}_{t} , 21}^{- 1} + {Σ}_{{s}_{t} , 22}^{- 1} )}^{- 1} \times \\ ( {Σ}_{{s}_{t} , 21}^{- 1} + {Σ}_{{s}_{t} , 22}^{- 1} ) \times \\ ( {p}_{2 , t - 1} - {μ}_{{s}_{t} , 1} + {μ}_{{s}_{t} , 2} ) + {μ}_{{s}_{t} , 1}\end{matrix} & \begin{matrix}\begin{matrix}\begin{matrix}( 10 ) \\ ( 11 )\end{matrix} \\ ( 12 )\end{matrix} \\ ( 13 )\end{matrix}\end{matrix}$$

It is possible to generate position p₂,ₜ of the object satisfying a dynamic constraint by performing the sampling from the Gaussian distribution having the average and the dispersion. In other words, the following equation is established.

[Mathematical Formula 25]

p_{2,t}˜P(p_{2,t}|sₜ, p_{2,t-1})=N(p_{2,t}|Σ′, μ′) (14)

In a case where a state sequence is already known, it is possible to generate a track by repeating a sequential sampling using Equation (14). However, it cannot be said that the operation applied to the object is limited to the track included in the learning. Therefore, a startup generated in an obscure state will be considered. In a case where state sₜ₋₁ at time t−1 and position p₂,ₜ₋₁ of the object at that moment are given, an expected value of the position p₂,ₜ of the object at time t is expressed as the following equation.

[Mathematical Formula 26]

p̅_{2,t}=∫∫p_{2,t}P(p_{2,t}|sₜ, p_{2,t-1})×P(sₜ|sₜ₋₁, p_{2,t-1})dp_{2,t}dsₜ (15)

In this way, an obscure track in such a state can be generated. However, since it is difficult to analytically solve the integration, an approximation is performed using Monte Carlo methods. First, the following sampling is repeated by N times, and N sampling values are obtained at time t.

(p₁, . . . , pₙ, . . . , p_{N}) [Mathematical Formula 27]

[Mathematical Formula 28]

sₙ˜P(sₙ|sₜ₋₁, p_{2,t-1}) (16)

pₙ˜P(pₙ|sₙ, p_{2,t-1}) (17)

However, the following Expression 29 of Equation (16) is obtained using a part of a state transition probability (Expression 30) as follows.

P(sₙ|sₜ₋ₜ, p_{2,t-1}) [Mathematical Formula 29]

P(sₜ|s₋ₜ, β, α) [Mathematical Formula 30]

P(sₙ|sₜ₋₁, p_{2,t-1})∝nₛ_{_{t−}}_{,s}_{ₙ}+αβₖ [Mathematical Formula 31]

The following Expression 32 of Equation (17) uses Equation (14) in consideration of the dynamic constraint.

P(pₙ|sₜ, p_{2,t-1}) [Mathematical Formula 32]

Finally, an average value of the N sampling values is assumed as a prediction value of the position of the object at time t.

$$\begin{matrix}[ Mathematical Formula 33 ] & \\ {p}_{2 , t} = \frac{1}{N} {\sum }_{n}^{N} {p}_{n} & ( 18 )\end{matrix}$$

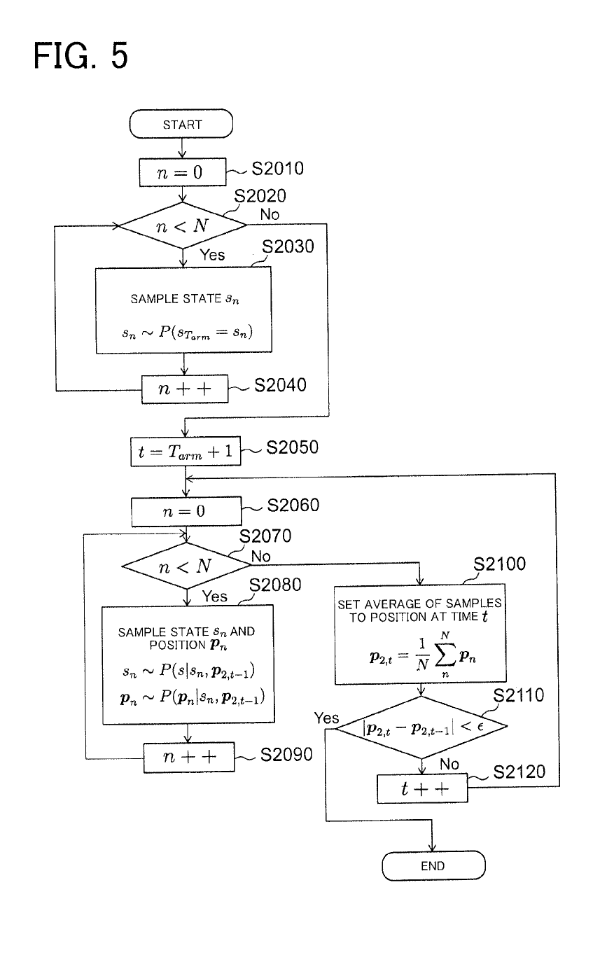

FIG. 5 is a flowchart illustrating a sequence of prediction by the prediction unit 107.

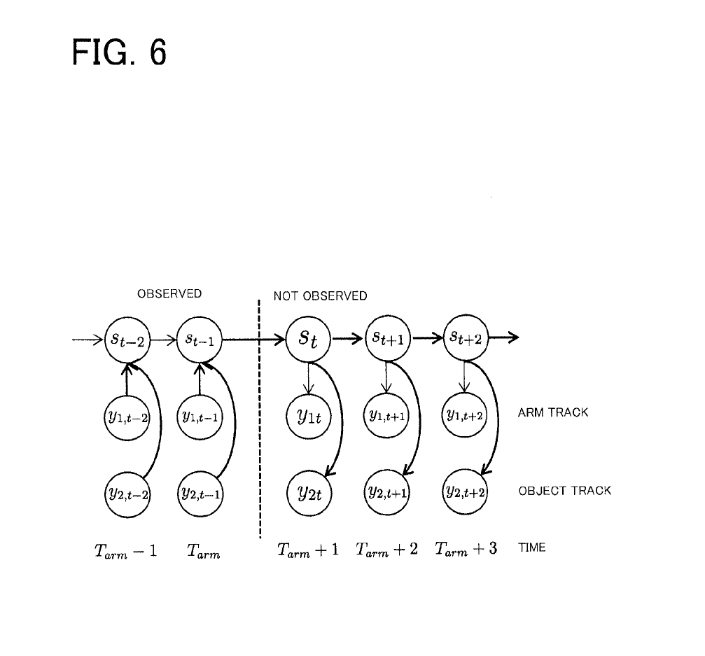

FIG. 6 is a diagram illustrating states before time Tarm at which observation is performed and a state after a collision (after time Tarm+1). After time Tarm+1, a track of the object is predicted using Equations (16) to (18).

Herein, assuming that only the track of the arm between time 0 to time Tarm is observed and a probability P (s_{Tarm}=k) in state k at time Tarm and an initial value p₂,_{Tarm} of the object are given, the track of the object is generated. The state at time Tarm is expressed by the following equation.

P(s_{T}_{ₐᵣₘ})=P(s_{T}_{ₐᵣₘ}|s_{T}_{ₐᵣₘ}₋₁, y_{1,T}_{ₐᵣₘ}, y₂,T_{ₐᵣₘ}) [Mathematical Formula 34]

In Step S2010 of FIG. 5, the prediction unit 107 sets n to 0.

In Step S2020 of FIG. 5, the prediction unit 107 determines whether n is less than a predetermined value N. In a case where n is less than the predetermined value N, the process proceeds to Step S2030. In a case where n is not less than the predetermined value N, the process proceeds to Step S2050.

In Step S2030 of FIG. 5, the prediction unit 107 samples the state sₙ by N times according to the following equation, and initializes position pₙ of each sample.

[Mathematical Formula 35]

sₙ˜P(s_{T}_{ₐᵣₘ}=sₙ) for all n (19)

pₙ=P_{2,t-1} for all n (20)

In Step S2040 of FIG. 5, the prediction unit 107 adds 1 to n. In Step S2040, “++” represents an increase by 1. After the process of Step S2040 is ended, the process returns to Step S2020.

In Step S2050 of FIG. 5, the prediction unit 107 progresses time.

In Step S2060 of FIG. 5, the prediction unit 107 sets n to 0 (zero).

In Step S2070 of FIG. 5, the prediction unit 107 determines whether n is less than a predetermined value N. In a case where n is less than the predetermined value N, the process proceeds to Step S2080. In a case where n is not less than the predetermined value N, the process proceeds to Step S2100.

In Step S2080 of FIG. 5, the prediction unit 107 samples a new state and a position of the object according to the following equation.

[Mathematical Formula 36]

sₙ˜P(s|sₙ, p_{2,t-1}) for all n (21)

pₙ˜P(pₙ|sₙ, p_{2,t-1}) for all n (22)

Herein, Equation (21) corresponds to Equation (16), and Equation (22) corresponds to Equation (17).

In Step S2090 of FIG. 5, the prediction unit 107 adds 1 to n. In Step S2090, “++” represents an addition by 1. When the process of Step S2090 is ended, the process returns to Step S2070.

In Step S2100 of FIG. 5, the prediction unit 107 sets an average of all sampling values obtained by the following equation to the prediction value of the position of the object at time t.

$$\begin{matrix}[ Mathematical Formula 37 ] & \\ {p}_{2 , t} = \frac{1}{N} {\sum }_{n}^{N} {p}_{n} & ( 23 )\end{matrix}$$

In Step S2110 of FIG. 5, the prediction unit 107 determines whether the object is at a stop. Specifically, in a case where a difference between a position of the object at time t−1 and a position of the object at time t is equal to or less than a predetermined value ε, it is determined that the object is at a stop. In a case where the object is at a stop, the process is ended. In a case where the object is not at a stop, the process proceeds to Step S2120.

In Step S2120 of FIG. 5, the prediction unit 107 adds 1 (an increment of time) to t. In Step S2120, “++” represents an addition by 1. After the process of Step S2120 is ended, the process returns to Step S2060.

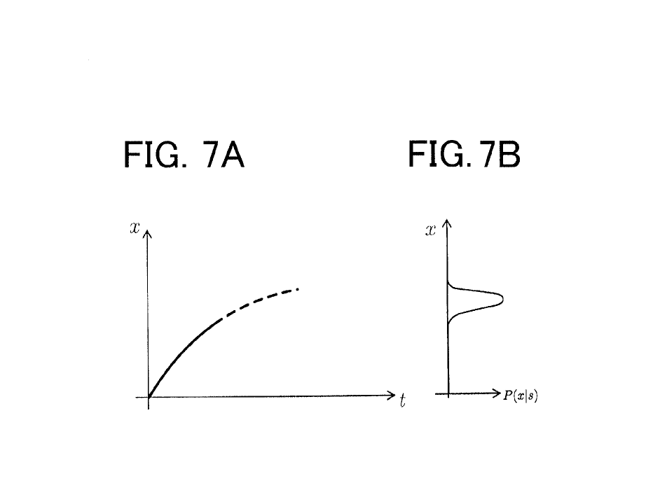

FIGS. 7A and 7B are diagrams illustrating a concept of prediction by the prediction unit 107. FIG. 7A is a diagram illustrating a relation between time and the observation value. The horizontal axis of FIG. 7A represents time, and the vertical axis represents the observation value of the position of the object. Further, the solid line represents the observation value of the position of the object which is actually observed, and the dotted line represents the prediction value of the position of the object. In FIGS. 7A and 7B, the observation values y₁ and y₂ are plotted in one dimension with respect to x. FIG. 7B is a diagram illustrating the probability distribution of the observation value of the position of the object. The horizontal axis of FIG. 7B represents the probability, and the vertical axis represents the position of the object. The prediction value (expected value) of the position of the object plotted by the dotted line is obtained using the probability distribution plotted in FIG. 7B.

Next, a simulation experiment of the prediction device 100 according to the embodiment will be described. The track of the arm and the track of the object when the arm of the robot touches the object are obtained by a simulator. The simulator is created by a physical calculation engine (Open Dynamic Engine (ODE)) (http://www.ode.org/). According to ODE, a collision, a friction, and the like of the object can be simulated, and various types of information such as the position and the speed of the object on the simulator can be obtained.

In the embodiment, assuming a sphere having a radius of 10 centimeters as the object, the track of the arm and the track of the object are obtained by ODE in a case where the robot applies a force on the object from the side and in a case where a force is applied from the upside.

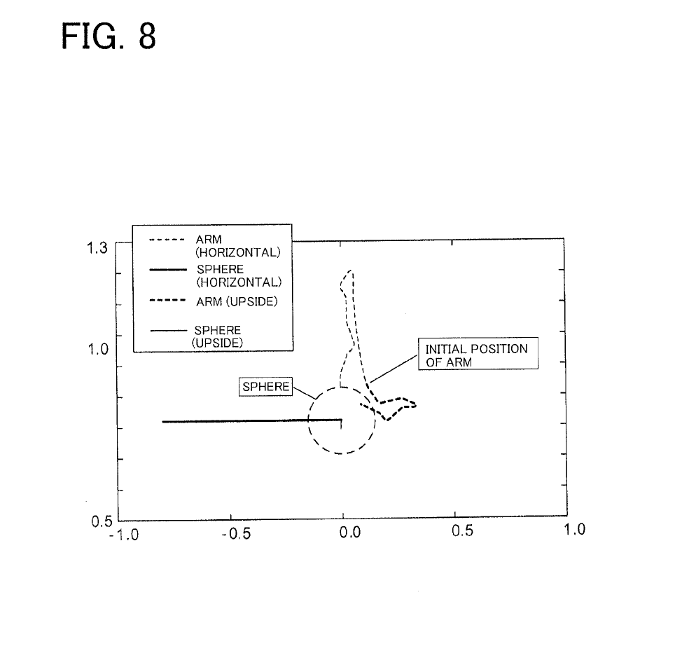

FIG. 8 is a diagram illustrating the track of the arm and the track of the object (the sphere). The horizontal axis of FIG. 8 represents coordinates in the horizontal direction, and the vertical axis represents coordinates in the vertical direction. The bold dotted line represents the track of the arm in a case where a force is applied to the sphere from the side. The arm moves the object from an initial position to the right, and then goes toward the sphere in the left direction. The bold solid line shows the track of the sphere after the collision with the arm. The sphere moves to the left direction. The fine dotted line shows the track of the arm in a case where a force is applied to the sphere from the upside. The arm moves from the initial position to the upside of the object, and then goes toward the sphere in the lower direction. The fine solid line shows the track of the sphere after the collision with the arm. Since the sphere is left on a table, the sphere remains at that place without moving.

Actually, as a result of learning the track illustrated in FIG. 8 according to the sequence illustrated in FIG. 3, the number of states comes to 6.

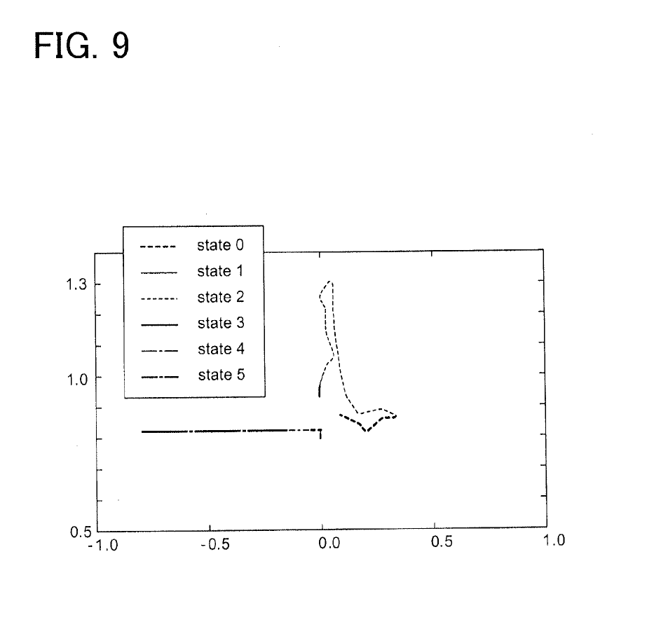

FIG. 9 is a diagram illustrating the six states obtained by learning. In FIG. 9, state 2 shows a movement to the upper direction and a movement to the horizontal direction of the arm having no relation with the collision with the object. State 0 shows a movement to the left direction of the arm and a touching with the sphere. State is a state in which the speed of the sphere becomes faster after the touching. State 5 transitioned from state 4 is a state until the sphere is decelerated and stopped after the touching. State 1 is a state in which the arm goes to the lower direction and touches the sphere, and state 3 transitioned from state 1 is a state in which the sphere and the arm are left stopped at that place. In this way, the movement of the robot and the track of the object are classified into meaningful states by the learning using the model 105.

Next, the track of the object is generated according to the sequence illustrated in FIG. 5. In order to verify whether the learned track is correctly generated, a track starting from state 0 as a case where the arm collides with the sphere from the side and a track starting from state 1 as a case where the arm collides with the sphere from the upside are generated.

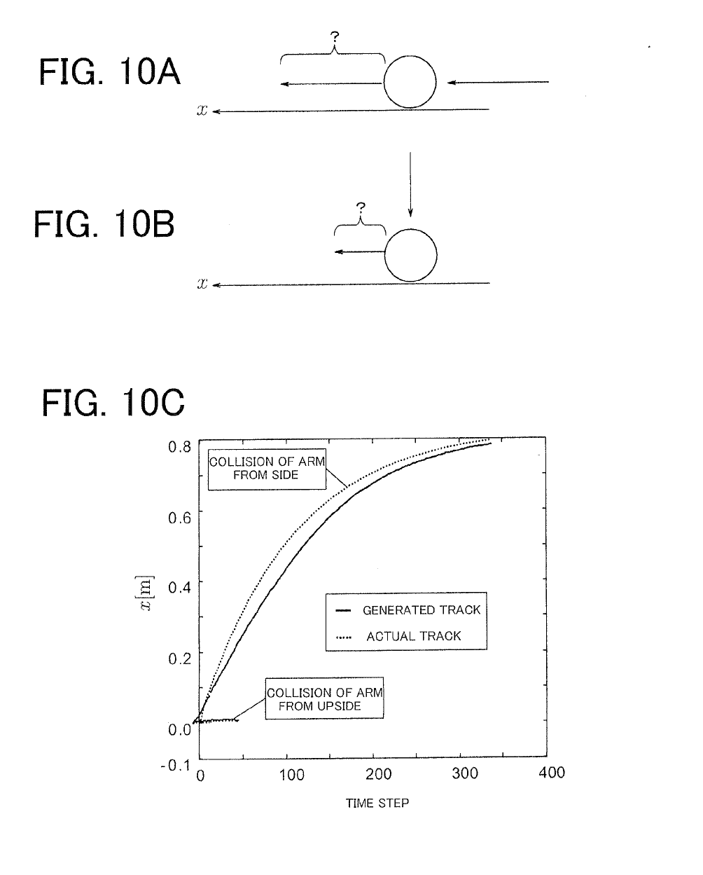

FIGS. 10A to 10C are diagrams illustrating a known track generated by the prediction unit 107. FIG. 10A is a diagram for describing a case where the arm collides with the sphere from the side. FIG. 10B is a diagram for describing a case where the arm collides with the sphere from the upside. Herein, x represents a coordinate of the object (the sphere) in the horizontal direction. FIG. 10C is a diagram illustrating the generated track. The horizontal axis of FIG. 10C represents time steps, and the vertical axis represents the coordinate x of the object (the sphere) in the horizontal direction. The coordinate x may be considered as a moving distance of the sphere. The solid line represents the track generated by the prediction unit 107, and the dotted line represents an actual track (the track obtained by simulation). Even though the track generated by the prediction unit 107 is not exactly matched with the actual track, it can be correctly predicted that the sphere is moved by about 0.8 meters in a case where the sphere collides with the arm from the side and the sphere is left stopped at that place in a case where the sphere collides with the arm from the upside. Further, in FIG. 10C, the state varies on the way in the predicted track, but the smooth track is generated.

Next, as a prediction on an unknown track, a track is predicted in a case where the arm obliquely collides with the object.

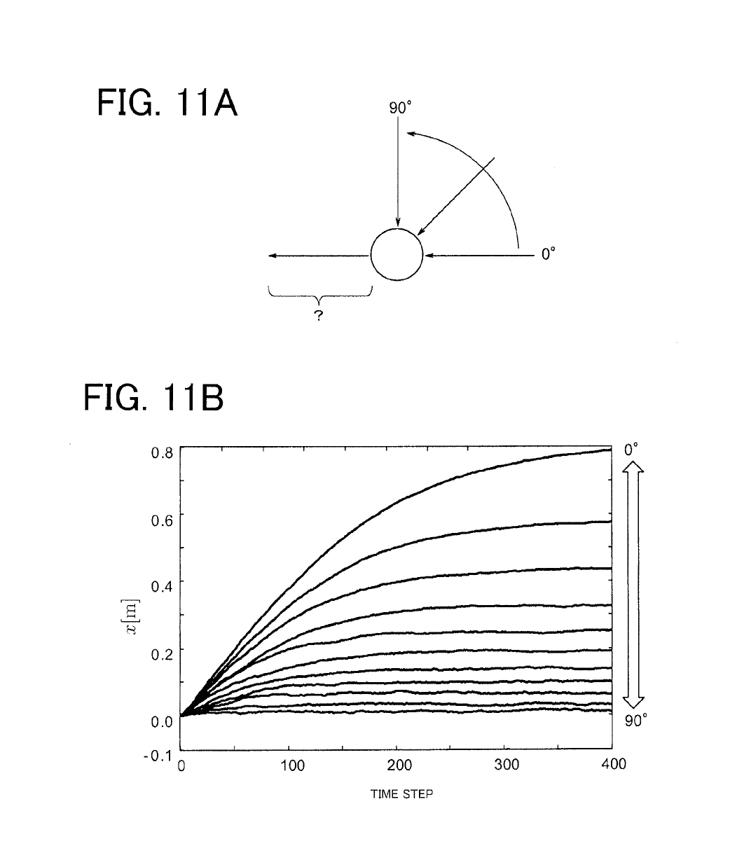

FIGS. 11A and 11B are diagrams illustrating an unknown track which is generated by the prediction unit 107. FIG. 11A is a diagram for describing a case where the arm obliquely collides with the sphere. An angle in a case where the arm collides with the sphere from the horizontal direction is 0°, and an angle in a case where the arm collides with the sphere in the vertical direction from the upside is 90°. FIG. 11B is a diagram illustrating the generated track. The horizontal axis of FIG. 11B represents time steps, and the vertical axis represents coordinates of the object (the sphere) in the horizontal direction, that is, a moving distance of the sphere. According to FIG. 11B, as the track of the arm approaches the horizontal direction (0°), a moving distance of the object becomes long, and as the track of the arm approaches the vertical direction (90°), a moving distance of the object becomes short. In this way, it is confirmed that an unknown track can be predicted by the prediction unit 107. Further, “vibration” of the track in FIG. 11B can be removed by increasing the number N of sampling times.

In the above description, the case where y₁ is information of the arm of the robot and y₂ is information of the object (for example, a ball) has been given as an example. However, the invention can also be applied to other cases, of course. Herein, another specific example to which the invention is applicable will be described.

In the first place, a case where the invention is applied to relations between an object and an object, a person and a person, a vehicle and a person, a vehicle and a vehicle, and the like may be considered. By setting 4-dimensional data of the position and the speed of one in each pair to y₁, and 4-dimensional data of the position and the speed of the other to y₂, it is possible to learn a relation between y₁ and y₂ and to predict information of the other from the one in each pair. For example, considering a case where a person (y₁) and a person (y₂) pass by one another, it is possible to predict a possibility of various behaviors of a person; for example, if y₁ unexpectedly steps aside to the left side, y₂ goes to the opposite side, or if y₁ expectedly walks in the middle of the road, y₂ is likely to go to some direction.

Next, there is considered a case where the invention is applied to a relation between a color of the signal in an intersection and a speed of a vehicle. In this case, the position and the speed of the vehicle is y₁, and the color of the signal is y₂. Since the color of the signal is one of three values (red, blue, and yellow), θ₂ is set as a parameter of the multinomial distribution, and H₂ is set as a parameter of a Dirichlet distribution. The position and the speed of the vehicle y₁, for example, are considered in a coordinate system of which the origin is the center of the intersection. Therefore, a relation between y₁ and y₂ is learned according to the method of the invention, and for example, in a case where the color (y₂) of the signal is changed to yellow at the time of the current position and the current speed (y₁) of the vehicle, a future position and a future speed (y₁) of the vehicle can be predicted. Furthermore, the track of the vehicle can be predicted according to the invention. In addition, the change of a behavior (y₁) of the vehicle can also be learned according to timing when the color (y₂) of the signal is changed.

Further, a gender (y₃) of a driver, a model (y₄) of a vehicle, an age (y₅) of a driver, and the like may be added as observation information, and thus a relation among y₁ to y₅ can be grasped. In this case, θ₃ to θ₅ become parameters of the multinomial distribution which has morphisms as many as these elements, and H₃ to H₅ become parameters of a Dirichlet prior distribution.

What is claimed is:

1. A prediction device comprising:
an observation unit configured to acquire an observation value of an observation target object;
a learning unit configured to learn a transition probability and a probability distribution of a model from time series data of the observation value, wherein
the model represents states of the observation target object and includes the transition probability between a plurality of states and the probability distribution of the observation value which corresponds to each state; and
a prediction unit, using the time series data of the observation value before a predetermined time, configured to predict a state at the predetermined time based on the transition probability and to predict an observation value corresponding to the state at the predetermined time based on the probability distribution.

2. The prediction device according to claim 1, wherein
the prediction unit is configured to
obtain the state at the predetermined time and a plurality of sampling values of the observation value corresponding to the state, and
set an average value of the plurality of sampling values to a prediction value of the observation value.

3. The prediction device according to claim 1, wherein
the observation value includes a position and a speed of the observation target object, and
the prediction unit is configured to perform the prediction using the probability distribution of the position of the observation target object.

4. The prediction device according to claim 1, wherein
the model is a hierarchical Dirichlet process-hidden Markov model and the learning unit is configured to perform learning by Gibbs sampling.

5. A prediction method which predicts an observation value using a model, wherein
the model represents states of an observation target object and includes a transition probability between a plurality of states and a probability distribution of an observation value which corresponds to each state,
the prediction method comprising:
obtaining an observation value of the observation target object;
learning the transition probability and the probability distribution of the model from time series data of the observation value; and
predicting, using the time series data of the observation value before a predetermined time, a state at the predetermined time based on the transition probability and to predict an observation value corresponding to the state at the predetermined time based on the probability distribution.

6. The prediction method according to claim 5, wherein
the predicting comprises
obtaining the state at the predetermined time and a plurality of sampling values of the observation value corresponding to the state, and
setting an average value of the plurality of sampling values to a prediction value of the observation value.

7. The prediction method according to claim 5, wherein
the observation value includes a position and a speed of the observation target object, and
the predicting comprises performing the prediction using the probability distribution of the position of the observation target object.

8. The prediction method according to claim 5, wherein
the model is a hierarchical Dirichlet process-hidden Markov model, and
the learning comprises performing learning by Gibbs sampling.
